(19) United States
(12) Patent Application Publication
(10) Pub. No.: US 2007/0196806 A1
(43) Pub. Date: Aug. 23, 2007

(54) System for submitting and delivering content events to remote devices

(76) Inventors: Mikael Ljungman, Stockholm (SE); Hacan Akerberg, Stockholm (SE); David Levett, Los Angeles, CA (US)

Correspondence Address: MORRISON & FOERSTER, LLP, 555 WEST FIFTH STREET, SUITE 3500, LOS ANGELES, CA, 90013-1024, US

(21) Appl. No.: 11/544,222

(22) Filed: Oct. 6, 2006

(30) Foreign Application Priority Data
Feb. 17, 2006 (GB) 0603237.9

(51) Int. Cl. G09B 3/00

(52) U.S. Cl. 434/350; 705/1

(57) ABSTRACT

The present invention is directed to a system and method for selectively delivering multimedia content, such as sports highlights, a video clip, or a movie, to a mobile communication device, such as a cellular telephone, a laptop computer, or a personal digital assistant. In particular, a content service provider receives multimedia content from a variety of content providers, such as television broadcasters, Internet website operators, or individual users, and categorizes the content in accordance with certain predetermined criteria. At the same time, the content service provider receives, from various different mobile communication devices, a preference to receive certain category of multimedia content. In accordance with the preferred embodiment, shortened versions or highlights of the multimedia content (such as the sores of a basket ball game), referred as notification messages, are sent to the mobile communication devices, the notification messages are sent to the users who have expressed an interest to receive the type of content indicated by the notification message. Upon receiving a request from the users in response to the notification messages, the multimedia content corresponding to the notification message is delivered to the user's mobile communication device.

### BACKGROUND

1. Field of Invention

The present invention is directed to a system and method for the streaming of media content to a remote device in response to an event followed by an acknowledged prompt to a user of the device, as well as system and methods for identifying media content of interest to device user, system and methods for cataloguing and archiving media content of interest, and system and methods for delivering the content and displaying it on the remote device.

2. Description of Related Art

Prior art content delivery and display mechanisms exist whereby a user can search or browse for content stored on one or more content repositories accessible over a network.

In some cases, content is transmitted continuously over a wired or wireless network via one or more distinct channels whereby the user navigates to or selects the appropriate channel displaying the desired content. Examples of this include radio and television broadcasting where a channel is chosen by tuning a remote receiver to a specific carrier frequency and the content is extracted by decoding the signal received into an appropriate audiovisual form

An extension to the previous case is where content is broadcast to a remote device but can only be encoded for viewing as a result of an additional payment such as cable or satellite broadcast pay per view movies and events. Furthermore it is known that such content can be obtained on demand Such that it can be viewed at a convenient time for the end user of the remote device.

It is known that there are mechanisms for delivering audio and video content via an Internet connection to a remote server where this content can be found via a search engine or by browsing through text, audio and/or visual descriptions of the available content. The content is streamed to the remote device as a result of selecting a hyperlink in the form of a text link or picture.

In a further existing example, audios and/or video clips can be sent embedded in messages (for example e-mail and MMS messages) delivered to a remote device.

A further example of mechanisms for delivering streaming content that has arisen as an extension of ‘Blogging’ is known as Podcasting, whereby an individual can pre-record audio and potentially video content in a form that can be downloaded on an occasional regular basis to a device suitable for playing back the content.

Each of the above solutions provides a means to delivering audio and/or video content on request by a user of a remote device. These methods require that content is available in a searchable or browsable form or alternatively that a message containing the content is transmitted to the remote device.

However, in certain circumstances it is desirable to provide a user with a prompt that a specific event that a user has subscribed to has occurred or is occurring and allows the user the option to play the content as either a delayed or live stream.

For example, a motor sport fan might request that that they be notified at the start of the race, at key event points in the race and at the finish. In message can be sent to the remote device in response to an event trigger notifying the user that a key event is about to happen or that an instant replay is available. Similar scenarios could be devised for other sporting events, awards ceremonies, news, weather etc.

In addition to live or via live streaming scenarios, there are numerous examples of content to which a user may wish to subscribe such as joke video clips, content relating to a hobby or other interest or even recurring mini-series provided by amateur or professional sources.

### SUMMARY OF THE PRESENT INVENTION

The present invention is predicated on the insight that a user of a remote device may in some cases not be interested in receiving a continuous stream of content as they may be occupied with other tasks. However, the user may be interested in being informed about certain key events for which content can be generated.

Rather than automatically transmit content relating to an event, the preferred embodiments of the present invention first sends details of the event such as a goal scored in a match, and allows the user to optionally choose whether to view the available content.

In the first aspect of this invention, a system is provided for enabling the user to subscribe to a service that delivers streaming content to a receiving device in response to the user acknowledging the events to be of interest. The system allows the user to register one or more remote devices (e.g., cell phones or PDAs) to which suitable events should be sent. In accordance with the preferred embodiment, methods are provided to enable the user to specify one or more sources of credits that may be used as methods of payment for any premium content that is received.

A second aspect of the present invention provides a system that allows a user to specify trigger conditions for one or more desired events. Information about the desired events can be entered for one or more remote devices. Included in this aspect are methods for a user to specify an acceptable cost/fee associated with the delivery of each event.

In a third aspect of the invention there is a system that receives streams of live and pre-recorded content that might be of interest to one or more remote users. In accordance with this aspect of the present invention, a mechanism is provided for describing the content in such a way that an event monitoring system can determine potential matches of incoming content against pre-specified events supplied by potential content recipients. Included in this aspect are methods for a content provider to specify an acceptable cost associated with the provision of the content.

In a fourth aspect of the invention, a system is provided for matching incoming content against pre-specified desired events requested by end users, subject to matching acceptable costs specified by providers and potential recipients.

In a fifth of aspect of the invention there is a system for notifying an end user of a requested matching event has occurred along with the associated cost of delivering such an event should such cost exist.

In a sixth aspect of the invention there is a system for enabling an end user to accept/or reject a notified event along with its associated cost.

In a seventh aspect of the invention there is a system for delivering content associated with an event that has been accepted by an end user.

In an eight aspect of the invention there is a billing system that deducts credits from the end user who has received the content successfully, credits a content provider accordingly and optionally deducts a suitable transaction fee for acting as an intermediary.

Further aspects and details of the invention are specified in the appended claims.

### BRIEF DESCRIPTION OF THE DRAWINGS

FIG. 1 is a schematic illustration of a system for delivering content to remote devices in accordance with the preferred embodiment of the present invention;

FIG. 2 is a flow chart illustrating a method of requesting delivery of content to remote devices in accordance with the preferred embodiment of the present invention; and

FIG. 3 is a flow chart illustrating a method of selectively delivering content to remote devices in accordance with the preferred embodiment of the present invention.

### DETAILED DESCRIPTION OF A PREFERRED IMPLEMENTATION

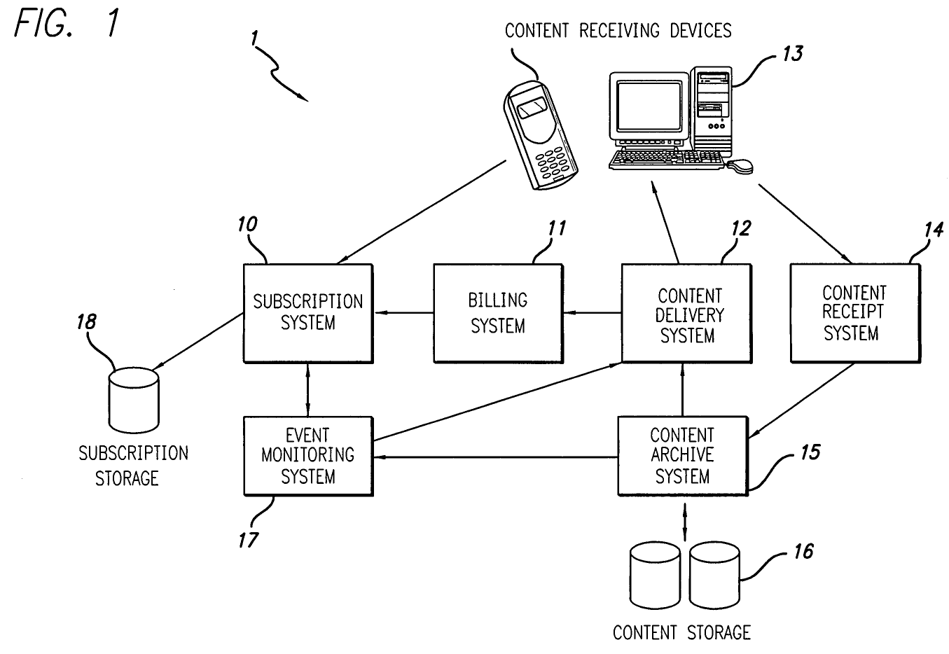

The present invention will be described with reference to the accompanying drawings, in which FIGS. 1 to 3 are schematics of the overall system architecture for delivering event triggered content in accordance with the present invention. The president invention will be described with reference to a preferred embodiment hereinafter referred to as the ‘Content Event Streaming System (CESS). The CESS incorporates processes that cover the majority of aspects of the present intention in a way that is designed to deliver content to web users on typical desktop and laptop computers via standard Internet browsers as well as users of mobile phones capable of presenting the content.

FIG. 1 illustrates the key components of the CESS 1 in accordance with the preferred embodiment of the present invention. Specifically, the CESS includes subscription subsystem 10, which provides an interface to the user to manage their account and specify content events that are of interest to them (hereinafter referred to as “user event content specification/request”). Information received that is related to user subscriptions is maintained in the subscriptions storage database. A user of the system may manage their account either via the remote device directly (e.g., using a cell phone), or via a separate device (such as a computer terminal).

Referring back to FIG. 1, the billing subsystem 11 manages financial transactions involved in prepaying for content, charging for content and crediting content providers accordingly.

The content receipt subsystem 14 provides the ability for users to upload pre-recorded content or connect a live content streaming source. Content that is uploaded by a user is stored for a period of time in the content archive 15 and its associated storage databases. A variety of methods may be used to upload content from a user device to the content archive. For instance, content may be uploaded from a computer terminal separate from the remote device that captured/created the content, or directly from the remote device itself.

Again referring back to FIG. 1, the event monitoring subsystem 17 analyzes the descriptions of each item of content uploaded to the system and identifies end users whose event content specification/request matches the description.

The content delivery subsystem 12 notifies each end user of content that matches their event content specification/request, and streams the content to the remote device, either automatically or upon user acknowledgement and confirmation of the request.

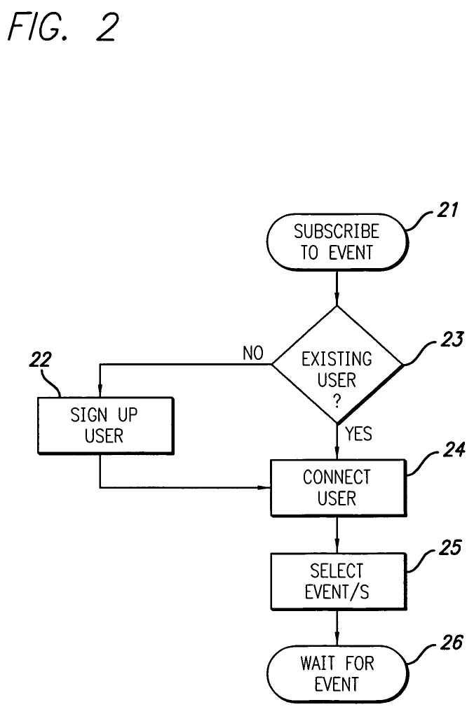

In accordance with the preferred embodiment, a user can access the CESS from a traditional Internet browser on a computer or mobile phone by navigating to a known Internet address in order to subscribe to a content event for present or future download. As shown in FIG. 2, on connecting 21 to this address the user is prompted 23 for their user ID and password or alternatively offered the opportunity to subscribe 22 as a new user. If a user is subscribing as a new user, a unique user ID is requested along with a password, a valid e-mail address and optionally additional profile information that will enable the system to advertise potential content of interest to that user via e-mail or direct to the device. In order to verify the user and reduce potential abuse of the system, a verification message is preferably sent to their e-mail address with a link that has to be selected before their account is activated. As further shown in FIG. 2, once the user is authenticated, the user is asked 25 to select events which the user wishes to receive, after which the system awaits 26 for the event upon which related content is delivered to the user.

As a part of the subscription process, the user is offered the opportunity to enter a form of payment/credit that may be deducted/drawn against should they wish to subscribe for content to which there is a cost associated (e.g., premium content). A user who accepts this service is given the opportunity to specify a prepaid amount against which charges will be made as content is delivered. This mechanism enables the CESS to reduce potential fraudulent use of invalid forms of credit and minimizes the transaction costs associated with micro payments for each piece of content delivered.

In accordance with the preferred embodiment, a user who connects to CESS using a valid username and password is offered the option to replenish their prepaid credit account to ensure that there is sufficient funds in the account of delivering their desired content.

In accordance with the preferred embodiment, a connected user, wherein the connection is made via one of Internet, Wi-Fi, or cellular connection (e.g., CDMA, GSM), is offered the opportunity to search and/or browse for potential content events of interest held within a catalogue on the system along with a means to select which events for which they desire to be notified. In addition a mechanism/interface may be provided to allow the user to remove or modify the conditions for pre-subscribed events.

In accordance with the preferred embodiment, a connected user is also offered the opportunity to upload content of their own or content they expect to provide at some point in the future.

In accordance with another aspect of the preferred embodiment, a system is provided to enable content recipients to rate the quality and accuracy of the content they have received, and this rating is displayed along with a description in the catalogue that users browse to select their desired content events.

The CESS also preferably allows for official or prequalified content providers, such as TV sports channels, to advertise their content in a branded way. For the commercial convent providers, the preferred embodiment of the present invention offers a more extensive set of tools for uploading content and creating schedules of upcoming events available for streaming to the remote devices. The tools allow these content providers to rapidly categorize their content according to pre-stored templates that typically contain a generic description along with a default level of importance associated with such an event. For example, using the tools, a content provider may upload content relating to a recent score in a football match, select an appropriate template that has already been filled in to indicate that it relates to a score along with information about costs, level of importance, and place holders for entering the name of the scorer, time of the event and perhaps the single sentence describing a unique feature of the event.

In accordance with one embodiment of the present invention, users who have been pre-screened, or have achieved a given target threshold rating based on the history of ratings by other uses, may be allowed to specify future content events. A selection of the specified future events by the various pre-approved content providers may be assembled into an electronic programming guide that is accessible and searchable via either a remote communication device (such as a cell phone or a PDA) or a computer terminal that is connected to the Internet. Failure to deliver the scheduled content may cause a content provider to become disqualified from posting future content events, or may cause the ratings of the content provider to be lowered.

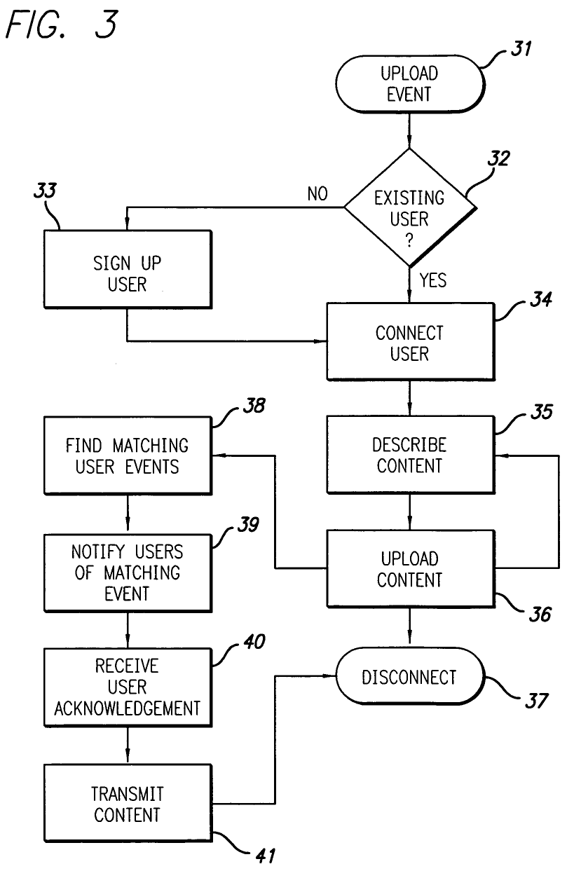

FIG. 3 illustrates the high level process flow of an uploading event 31 involved in uploading, matching and delivering content events in accordance with the preferred embodiment of the present invention. Specifically, as shown in FIG. 3, once an item of content has been uploaded 31 (or in a case of live streaming content, the stream has commenced) to CESS along with its description 35 and associated cost if any, the system searches for matching individuals who have requested such a content event. Before uploading 36 of the content, the content provider is asked 32 to identify him or herself as to whether he or she is an existing/registered user, or a new user. If the content provider is a new user, the content provider is presented 33 with the opportunity to become a registered user.

Once a matching user has been identified 38, in other words, once the system identifies other users who have expressed an interest in receiving content matching the description of the content uploaded by the content provider, a notification is sent 39 to matched users to alert them that the content is available. The notification preferably includes a brief description of the content and the cost associated with receiving it. The user has the option to accept 40 the delivery of the content or rejected it, optionally providing a reason for rejection such as too busy, too expensive or not relevant. Once the user accepts the delivery of the content, the content is transmitted 41 to that user.

In accordance with one embodiment of the present invention, an additional feature of CESS is the ability to temporarily cache the content events in its content archive system 15, allowing a user the option of delayed presentation of the content. For example, if there has been a score in a football match for which the user had expressed an interest, but that user is currently in a meeting or driving or for other reasons is unable to watch the content immediately, the user has the option to save the content event for a later viewing at some time in the future optionally limited by available storage space or validity period. Furthermore, should subsequent events happen within the lifetime of an existing event that has been saved, the user is offered the option to aggregate the content such that the multiple events can be viewed together.

In accordance with another embodiment of the present invention, users would be able to specify the degree of frequency or some other sensitivity measure that would limit the number of content events that are sent as notifications. For example, a user can choose to have the events sent no more than once every half an hour, subscribe only to half time and end of match summaries, or only subscribe to events that exceed a specific threshold of importance as determined by the content provider. In this way the user could limit the events to only those which would have a significant material impact to the outcome of the game.

In accordance with the preferred embodiment, upon termination 37 of delivery of the content the user is offered the opportunity to rate the content received which in turn updates the rating profile of the content provider. Should the termination occur prior to the complete delivery of the content, the users offered the opportunity to continue viewing at no additional cost to allow for a potential delivery problems such as disconnected networks that are outside of the user's control.

In accordance with the preferred embodiment, a user may at any time sign into their account using their username and password to view a complete history of their account showing costs incurred through content viewed as well as any credits they have received by providing content and has been viewed by other users.

Credit earned through providing useful content to other users is preferably aggregated and can be used as prepayment for receiving content provided by other users. Earned credit that exceeds a certain threshold limit can optionally be converted into cash by a user's chosen method such as online payment processing systems (e.g., PayPal) of credit card refunds. For certain pre-qualified content providers such as TV sports channels additional mechanisms exists that allow for a more formal auditing process along with the ability to pay for credits earned via bank transfer on a regular (e.g. monthly) basis.

What we claim:

1. A method for delivering multimedia content to a mobile communication device, said method comprising the steps of:
receiving, from a content provider, a multimedia content;
composing notification message, said notification message indicative of the multimedia content;
sending, to the mobile communication device, the notification media message;
receiving, from the mobile communication device, a request for receiving the multimedia content; and
delivering, to the mobile communication device, the requested multimedia content.

2. The method of claim 1, wherein said mobile communication device is one of a cellular phone and a personal digital assistant.

3. The method of claim 1, wherein said notification message and said multimedia content are transmitted over a wireless network.

4. The method of claim 1, wherein the notification message includes pricing information associated with the multimedia content.

5. The method of claim 1, further comprising the step of deducting financial credit from an account associated with the mobile communication device.

6. The method of claim 1, wherein the multimedia content includes video of a professional sports event, and wherein the notification message includes an score tally of the sports event.

7. The method of claim 1, further comprising the step of requesting, from the mobile communication device, a user ID and a password associated with the user ID.

8. A method for delivering multimedia content to a plurality of mobile communication devices, said method comprising the steps of:
receiving, from each of the plurality of mobile communication devices, a user criteria indicating of at least one category of desired multimedia content;
receiving, from a plurality of content providers, a plurality of multimedia content;
categorizing the received plurality of multimedia content;
selectively transmitting the categorized multimedia to selective ones of plurality of mobile communication devices, wherein at least some of the categorized multimedia content are transmitted to only the mobile communication devices from which a user criteria indicative of a matching category is received.

9. The method of claim 8, further comprising the steps of:
for at least some of the received multimedia content, composing a plurality of notification messages, said notification messages indicative of the respective multimedia content received;
sending, to the plurality of mobile communication devices, the notification media messages;
receiving, from at least some of the plurality of mobile communication device, at least one request for receiving a multimedia content; and
delivering, to the mobile communication devices from which requests are received, the requested multimedia content.

10. The method of claim 8, wherein said plurality of mobile communication devices is one of a cellular phone and a personal digital assistant.

11. The method of claim 9, wherein said notification messages and said multimedia content are transmitted over a wireless network.

12. The method of claim 9, wherein the notification message includes pricing information associated with the multimedia content.

13. The method of claim 8, further comprising the step of deducting financial credit from an account associated with the mobile communication device.

14. The method of claim 9, wherein the multimedia content include videos of professional sports events, and wherein the notification messages includes score tallies of the sports events.

15. The method of claim 8, further comprising the step of requesting, from the mobile communication device, a user ID and a password associated with the user ID.

16. A mobile communication device for selectively receiving video multimedia content, said mobile communication device comprising:
a display for displaying video multimedia content;
means for receiving, from a service provider, a notification message, said notification message indicative of a multimedia content;
means for causing the display to display the notification message;
means for sending, to the service provider, a request for receiving the multimedia content; and
means for receiving, from the service provider, the requested multimedia content.

17. The mobile communication device of claim 16, wherein said mobile communication device is one of a cellular phone and a personal digital assistant.

18. The mobile communication device of claim 16, wherein said notification message and said multimedia content are transmitted over a wireless network.

19. The mobile communication device of claim 16, wherein the notification message includes pricing information associated with the multimedia content.

20. The mobile communication device of claim 16, wherein the multimedia content includes video of a professional sports event, and wherein the notification message includes an score tally of the sports event.
